(19) United States
(12) Patent Application Publication
(10) Pub. No.: US 2026/0204204 A1
(43) Pub. Date: Jul. 16, 2026

(54) DISPLAY CONTROL CIRCUIT AND DISPLAY CONTROL METHOD

(71) Applicant: NOVATEK Microelectronics Corp., Hsinchu (TW)

(72) Inventors: Yi-Lung Chen, Tainan City (TW); Shu-Wei Chang, Tainan City (TW)

(73) Assignee: NOVATEK Microelectronics Corp., Hsinchu (TW)

(21) Appl. No.: 19/448,139

(22) Filed: Jan. 14, 2026

Related U.S. Application Data
(60) Provisional application No. 63/745,279, filed on Jan. 14, 2025.

(51) Int. Cl. G09G 3/20; G09G 3/34

(52) U.S. Cl. CPC G09G 3/2096; G09G 3/2007; G09G 3/3426; G09G 2310/06; G09G 2310/08; G09G 2320/0233; G09G 2320/0247; G09G 2320/062; G09G 2320/0686; G09G 2330/04; G09G 2380/10

(57) ABSTRACT

A display control circuit and a display control method are provided. The display control circuit includes a storage unit, a control register, a local dimming control register, and a microcontroller unit. The storage unit is configured to store a plurality of predefined LDC setting data. The control register is configured to store a first mode setting value. The local dimming control register is configured to store a LDC setting data that is to be applied in synchronization with a frame synchronization signal. The microcontroller unit is coupled to the control register and the local dimming control register. The microcontroller unit is configured to read a first predefined LDC setting data of the plurality of predefined LDC setting data stored in the storage unit according to the first mode setting value and write the first predefined LDC setting data into the local dimming control register.

### CROSS-REFERENCE TO RELATED APPLICATION

This application claims the priority benefit of U.S. provisional application serial no. 63/745,279, filed on January 14, 2025. The entirety of the above-mentioned patent application is hereby incorporated by reference herein and made a part of this specification.

### BACKGROUND

### Technical Field

The disclosure relates a control circuit; particularly, the disclosure relates to a display control circuit and a display control method.

### Description of Related Art

Traditional local dimming relies on a fixed set of parameters tailored to specific displays and backlights, which limits its effectiveness across diverse scenes or images. To address this, conventional methods involve the front-end system (such as MCU, SoC, or ECU) performing large-scale parameter adjustments on the driver IC based on the scene. However, the heavy command load occupies significant communication bus bandwidth, increasing the risk of command errors. Furthermore, because front-end commands are often not synchronized with the video frames and occur randomly across the active and blanking regions, they can cause backlight anomalies like over-brightness, under-brightness, or flickering. In automotive applications, these issues lead to serious driving safety concerns.

### SUMMARY

The display control circuit and the display control method of the disclosure may achieve rapid switching among different local dimming operation modes.

The display control circuit of the disclosure includes a storage unit, a control register, a local dimming control register, and a microcontroller unit. The storage unit is configured to store a plurality of predefined LDC setting data. The control register is configured to store a first mode setting value. The local dimming control register is configured to store a LDC setting data that is to be applied in synchronization with a frame synchronization signal. The microcontroller unit is coupled to the control register and the local dimming control register, and configured to read a first predefined LDC setting data of the plurality of predefined LDC setting data stored in the storage unit according to the first mode setting value and write the first predefined LDC setting data into the local dimming control register.

The display control method includes the following steps: storing a first mode setting value by a control register; storing a LDC setting data that is to be applied in synchronization with a frame synchronization signal by a local dimming control register; and reading a first predefined LDC setting data of a plurality of predefined LDC setting data stored in a storage unit by a microcontroller unit according to the first mode setting value, and writing the first predefined LDC setting data into a local dimming control register by the microcontroller unit. The local dimming control register is configured to store a predefined LDC setting data that is applied in synchronization with a frame synchronization signal.

Based on the above, according to the display control circuit and the display control method of the disclosure, the microcontroller unit may quickly write the predefined LDC setting data into the local dimming control register to achieve rapid switching among different local dimming operation modes.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit schematic diagram of a display control circuit according to an embodiment of the disclosure.

FIG. 2 is a flowchart of a display control method according to an embodiment of the disclosure.

FIG. 3 is a schematic diagram of relevant signals according to the embodiment of FIG. 1 of the disclosure.

FIG. 4 is a circuit schematic diagram of a display control circuit according to an embodiment of the disclosure.

FIG. 5 is a schematic diagram of relevant signals according to the embodiment of FIG. 4 of the disclosure.

FIG. 6 is another schematic diagram of relevant signals according to the embodiment of FIG. 4 of the disclosure.

FIG. 7 is a circuit schematic diagram of a display control circuit according to an embodiment of the disclosure.

FIG. 8 is a schematic diagram of relevant signals according to the embodiment of FIG. 7 of the disclosure.

### DESCRIPTION OF THE EMBODIMENTS

Reference is now made in detail to exemplary embodiments of the disclosure, and examples of the exemplary embodiments are illustrated in the accompanying drawings. Wherever possible, the same reference numerals are used in the drawings and descriptions to refer to the same or similar parts.

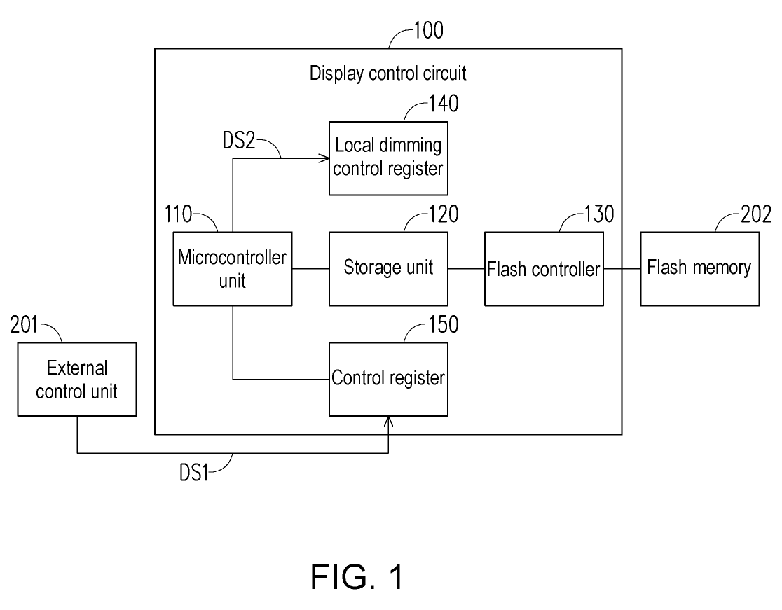

FIG. 1 is a circuit schematic diagram of a display control circuit according to an embodiment of the disclosure. Referring to FIG. 1, the display control circuit 100 includes a microcontroller unit (MCU) 110, a storage unit 120, a flash controller 130, a local dimming control (LDC) register 140, and a control register 150. The microcontroller unit 110 is coupled to the storage unit 120, the local dimming control register 140, and a control register 150. The storage unit 120 is further coupled to the flash controller 130. In the embodiment of the disclosure, the control register 150 is further coupled to an external control unit 201. The flash controller 130 is further coupled to a flash memory 202. In the embodiment of the disclosure, the local dimming control register 140 is configured to store a predefined LDC setting data that is applied in synchronization with a frame synchronization signal. The display control circuit 100 is configured to provide related backlight control signals for local dimming operation based on the predefined LDC setting data stored in the local dimming control register 140.

In one embodiment of the disclosure, the display control circuit 100, the external control unit 201, and the flash memory 202 may be integrated into in-vehicle equipment, such as an in-vehicle infotainment (IVI) system. The display control circuit 100 may be implemented in an integrated circuit (IC) which perform local dimming control of backlight, such as a bridge IC, a timing controller (TCON) IC, or a timing controller embedded display driver IC (TED), and the display control circuit 100 may be configured to providing display data and control signals for driving the display panel and a backlight panel of an instrument cluster or a center information display (CID). The external control unit 201 is a device separate from the display control circuit 100 and may be, for example, a system on chip (SOC), an electronic control unit (ECU), or a front-end MCU.

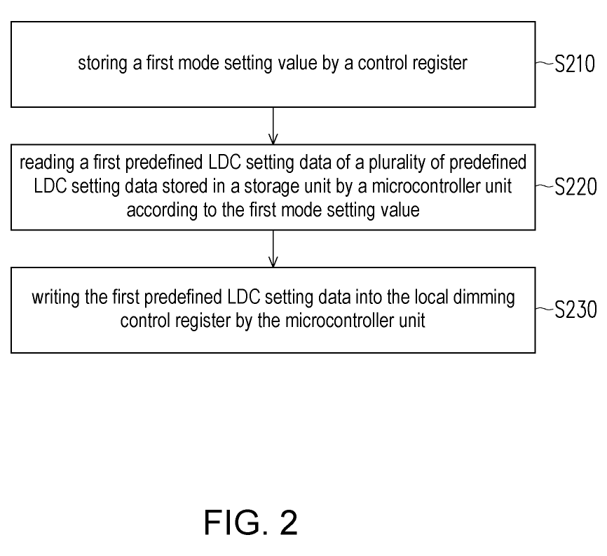

FIG. 2 is a flowchart of a display control method according to an embodiment of the disclosure. Referring to FIG. 1 and FIG. 2, the display control circuit 100 may execute the following steps S210 to S230. In the embodiment of the disclosure, when the display control circuit 100 is powered on, the flash controller 130 may read a plurality of predefined LDC setting data from the flash memory 202 in advance, and write the plurality of predefined LDC setting data into storage unit 120. In step S210, the control register 150 stores a first mode setting value. In the embodiment of the disclosure, the first mode setting value is carried in a mode setting command transmitted from the external control unit 201. In step S220, the microcontroller unit 110 reads a first predefined LDC setting data of the plurality of predefined LDC setting data stored in the storage unit 120 according to the first mode setting value. In step S230, the microcontroller unit 110 writes the first predefined LDC setting data into the local dimming control register 140. In the embodiment of the disclosure, the microcontroller unit 110 may perform fast read and write operations on the local dimming control register 140 through an internal bus between the microcontroller unit 110 and the local dimming control register 140. Therefore, the microcontroller unit 110 may finish reading and writing the first predefined LDC setting data during one frame period next to a frame period during which the microcontroller unit 110 receives the mode setting command from the external control unit 201. That is, the display control circuit 100 may implement quick switching of local dimming settings.

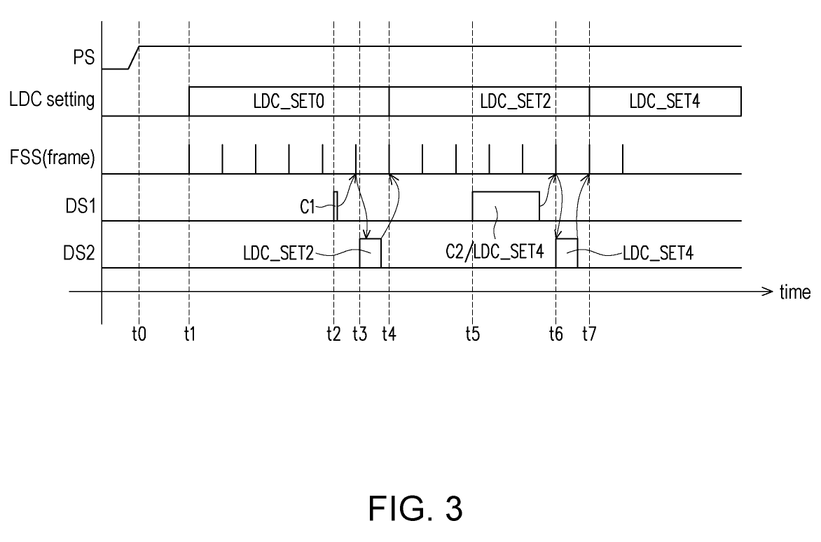

FIG. 3 is a schematic diagram of relevant signals according to the embodiment of FIG. 1 of the disclosure. Referring to FIG. 1 and FIG. 3, PS depicts a timing diagram of a power supplying state to the display control circuit 100; LDC setting depicts a timing diagram of LDC setting data stored in the local dimming control register 140; FSS depicts a timing diagram of a frame synchronization signal; DS1 depicts a timing diagram of a transmission from the external control unit 201 to the display control circuit 100; and DS2 depicts a timing diagram of a transmission on the internal bus between the microcontroller unit 110 and the local dimming control register 140. Referring to FIG. 1 and FIG. 3, the display control circuit 100 may be powered on at time t0. During a period between time t0 to time t1, the flash controller 130 may read a plurality of predefined LDC setting data (e.g., LDC_SET0 to LDC_SET3) from the flash memory 202 in advance, and write the plurality of predefined LDC setting data into storage unit 120. The plurality of predefined LDC setting data (e.g., LDC_SET0 to LDC_SET3) are used to set different local dimming control modes.

Moreover, before receiving a mode setting command for local dimming control, the microcontroller unit 110 first sets an initial local dimming control mode, which means the microcontroller unit 110 reads one of the plurality of predefined LDC setting data, e.g., LDC_SET0, from the storage unit 120 and writes the predefined LDC setting data LDC_SET0 into the local dimming control register 140 as an initial setting. The initial LDC setting data LDC_SET0 is applied in synchronization with a frame synchronization signal FSS.

Refer to the timing diagram DS1, at time t2, the control register 150 may receive a mode setting command C1 from the external control unit 201. The mode setting command C1 includes a mode setting value LDC_Mode, and the microcontroller unit 110 may take the mode setting value LDC_Mode which equals 2 as a reference to read a corresponding predefined LDC setting data LDC_SET2 from the storage unit 120. The control register 150 may store the mode setting value LDC_Mode=2.

Refer to the timing diagram DS2, at time t3, the microcontroller unit 110 may read the predefined LDC setting data LDC_SET2 from the storage unit 120 according to the mode setting value (LDC_Mode=2) and write the predefined LDC setting data LDC_SET2 to the local dimming control register 140. It should be noticed that the microcontroller unit 110 may finish reading and writing the corresponding predefined LDC setting data LDC_SET2 during one frame period from time t3 to time t4 next to the frame period during which the microcontroller unit 110 receives the mode setting command C1. Thus, at time t4, LDC setting data of the display control circuit 100 may be updated to the predefined LDC setting data e.g., LDC_SET2.

Moreover, at time t5, the external control unit 201 may transmit a mode setting command C2 carrying a mode setting value LDC_Mode=4 and a corresponding custom LDC setting data LDC_SET4 which is not prestored in the storage unit 120 into the display control circuit 100. The control register 150 may store the received mode setting value (LDC_Mode=4) and the input custom LDC setting data LDC_SET4.

At time t6, during one frame period (t6 to t7) next to the frame period during which the microcontroller unit 110 completes receiving the mode setting value and the custom LDC setting data LDC_SET4, the microcontroller unit 110 may read the input custom LDC setting data LDC_SET4 from the control register 150 according to the mode setting value LDC_Mode=4 and write the custom LDC setting data LDC_SET4 to the local dimming control register 140 through the internal bus between the microcontroller unit 110 and local dimming control register 140 Thus, at time t7, LDC setting data of the display control circuit 100 may be updated to the custom LDC setting data LDC_SET4.

Therefore, the microcontroller unit 110 may update LDC setting data during one frame period next to the frame period during which the microcontroller unit 110 completely receives the mode setting command accompanying with or without a custom LDC setting data from the external control unit 201. The display control circuit 100 may enable rapid switching of local dimming settings without producing unpredictable transient display results.

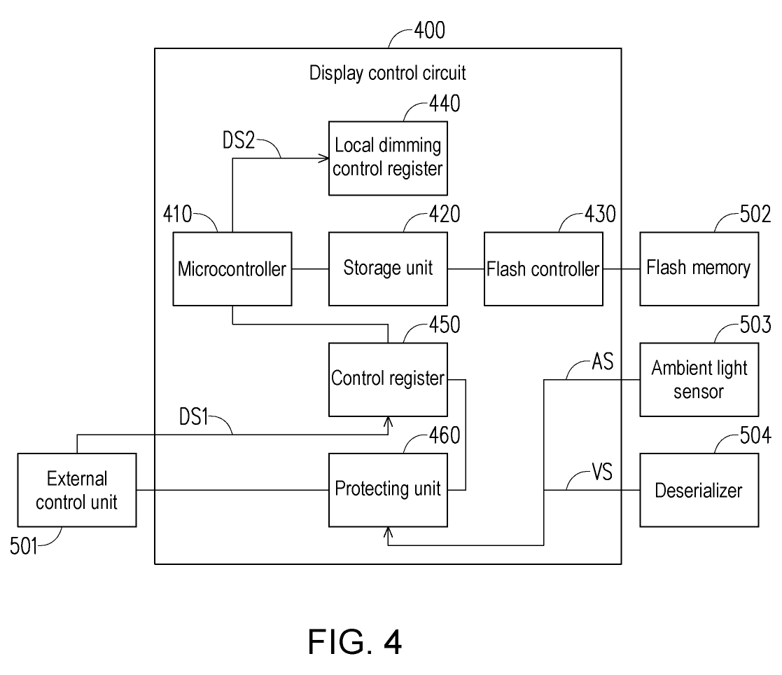

FIG. 4 is a circuit schematic diagram of a display control circuit according to an embodiment of the disclosure. Referring to FIG. 4, the display control circuit 400 includes a microcontroller unit 410, a storage unit 420, a flash controller 430, a local dimming control register 440, a control register 450, and a protecting unit 460. The microcontroller unit 410 is coupled to the storage unit 420, the local dimming control register 440, and a control register 450. The storage unit 420 is further coupled to the flash controller 430. The control register 450 is further coupled to the protecting unit 460. In the embodiment of the disclosure, the control register 450 is further coupled to an external control unit 501. The flash controller 430 is coupled to a flash memory 502. The protecting unit 460 is further coupled to an ambient light sensor 503 and a deserializer 504.

In the embodiment of the disclosure, the ambient light sensor 503 is configured to sense the brightness of ambient light (e.g., the ambient light inside or outside the car) to output an ambient light sensing signal AS to the protecting unit 460. The ambient light sensing signal AS may be transmitted to the display control circuit 400 either directly from the ambient light sensor 503 or via an automotive SoC. The deserializer 504 is configured to provide a video signal VS for driving the display panel to display corresponding video image. The deserializer 504 outputs the video signal VS to the protecting unit 460. The image transmission path of the video signal VS may be either from the automotive SoC through a serializer (not shown) and the deserializer 504 to the display control circuit 400, or directly from the automotive SoC to the display control circuit 400 without passing through the serializer and a deserializer 504.

In the embodiment of the disclosure, the protecting unit 460 is configured to analyze at least one of the ambient light sensing signal AS and the video signal VS. In addition, the relevant circuit features and technical details of the display control circuit 400 can be found in the embodiments illustrated in FIG. 1 to FIG. 2. The display control circuit 400 may also execute the display control method of the embodiment of FIG. 2.

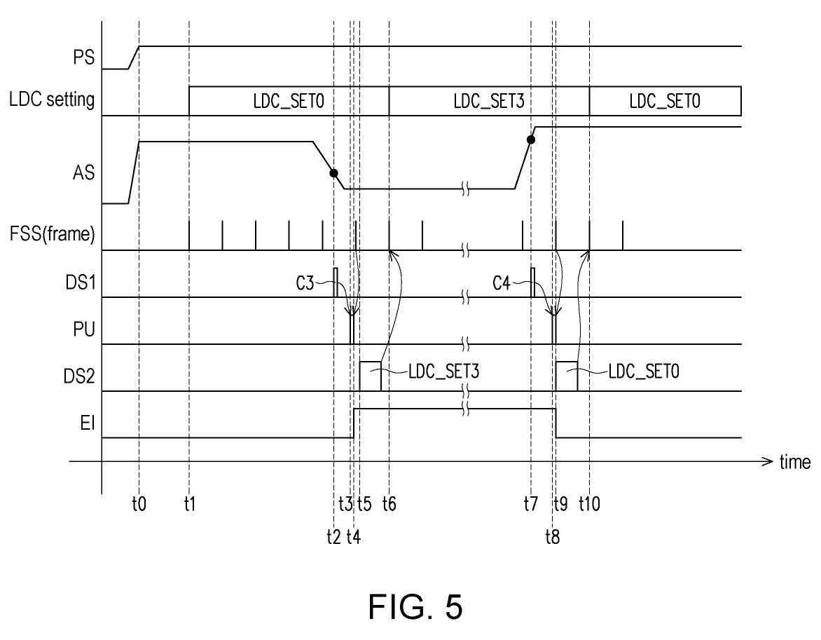

FIG. 5 is a schematic diagram of relevant signals according to the embodiment of FIG. 4 of the disclosure. Referring to FIG. 4 and FIG. 5, PS depicts a timing diagram of a power supplying state to the display control circuit 400; LDC setting depicts a timing diagram of LDC setting data stored in the local dimming control register 440; AS depicts a timing diagram of the ambient light sensing signal; FSS depicts a timing diagram of a frame synchronization signal; DS1 depicts a timing diagram of a transmission from the external control unit 501 to the display control circuit 400; PU depicts a timing diagram of the operation of the protecting unit 460; DS2 depicts a timing diagram of a transmission on the internal bus between the microcontroller unit 410 and the local dimming control register 440; and EI depicts a timing diagram of an error indication generated by the protecting unit 460. In one embodiment of the disclosure, the display control circuit 400 may be powered on at time t0. During a period between time t0 to time t1, the flash controller 430 may read a plurality of predefined LDC setting data (e.g., LDC_SET0 to LDC_SET3) from the flash memory 502 in advance, and write the plurality of predefined LDC setting data into storage unit 420.

Moreover, before receiving a mode setting command for local dimming control, the microcontroller unit 410 first sets an initial LDC mode, which means the microcontroller unit 410 reads one of the plurality of predefined LDC setting data, e.g., LDC_SET0, from the storage unit 120 and writes the predefined LDC setting data LDC_SET0 into the local dimming control register 440 as an initial setting. The initial LDC setting data LDC_SET0 is applied in synchronization with a frame synchronization signal FSS.

Refer to the timing diagram DS1, at time t2, when the brightness of ambient light is changed (e.g., the voltage level of the ambient light sensing signal AS becomes lower than a first threshold value when the vehicle enters a tunnel, for example), the external control unit 501 may output a mode setting command C3 including a mode setting value LDC_Mode which equals 3. Due to unexpected factors such as the misjudgment to the ambient light sensing signal by the external control unit 501 or electrostatic interference happening on the communication between the external control unit 501 and the display control circuit 400, the received mode setting value (LDC_Mode=3) does not conform to a LDC mode (such as LDC_Mode=2) expected to be applied in a condition of the vehicle travelling in a tunnel. The control register 450 may store the mode setting value LDC_Mode= 3.

Refer to the timing diagram PU, at a period from time t3 to time t4, the protecting unit 460 may determine whether the mode setting value carried in the mode setting command C3 is reasonable according to the ambient light sensing signal AS. The protecting unit 460 determines that the mode setting value (LDC_Mode=3) carried in the mode setting command C3 is not reasonable, and at the time t4, the protecting unit 460 generates an error indication EI with a logic high value corresponding to the determination result which presents that the mode setting value (LDC_Mode=3) is unreasonable, since the received mode setting value (LDC_Mode=3) does not conform to the expected LDC mode setting value which is used in a condition of the vehicle travelling in the tunnel, which is indicated by the ambient light sensing signal AS becoming lower than the first threshold value. In contrast, if the protecting unit 460 determines that a mode setting value carried in the received mode setting command is reasonable, the protecting unit 460 generates an error indication EI with a logic low value corresponding to a determination result which presents that the mode setting value is reasonable. The error indication EI may be a flag.

In another embodiment, at a period from time t3 to time t4, the protecting unit 460 may determine whether the mode setting value carried in the mode setting command C3 is reasonable according to an image analysis result. For example, when the protecting unit 460 determines that the LDC mode corresponding to the mode setting value (e.g., LDC_Mode=3) is used to enhance the brightness of a specific pattern in an input image frame, but by analyzing the input image frame from the video signal VS, the protecting unit 460 identifies there is no specific pattern in the input image frame that need to be specially illuminated, in such a condition the protecting unit 460 may determine the mode setting value carried in the mode setting command C3 is unreasonable. The protecting unit 460 may determine whether the input image frame contains the specific pattern through distinguishing characteristics such as histogram, frequency analysis, and gray level statistics. In contrast, when the protecting unit 460 determines that the LDC mode corresponding to the mode setting value (e.g., LDC mode=3) is used to enhance the brightness of a specific pattern in the input image frame, and the protecting unit 460 identifies that there is the specific pattern in the image that need to be specially illuminated according to the video signal VS, the protecting unit 460 may determine the mode setting value carried in the mode setting command C3 is reasonable.

After the protecting unit 460 generates the error indication EI corresponding to the determination result presenting that the mode setting value is unreasonable, during a period from time t5 to time t6, the microcontroller unit 410 still reads the predefined LDC setting data LDC_SET3 from the storage unit 420 according to the mode setting value and writes the predefined LDC setting data LDC_SET3 to the local dimming control register 440, even though the determination result presents that the mode setting value is unreasonable. Thus, at time t6, LDC setting data of the display control circuit 400 may be updated to the predefined LDC setting data LDC_SET3.

Selectively, in other embodiments of the disclosure, the microcontroller unit 410 may read the predefined LDC setting data LDC_SET3 from the storage unit 420 and write the predefined LDC setting data LDC_SET3 into the local dimming control register 440 only when the protecting unit 460 generates the error indication EI corresponding to the determination result presenting that the mode setting value is reasonable.

Refer to the timing diagram DS1 again, at time t7, when the brightness of ambient light is changed again (e.g., the voltage level of the ambient light sensing signal AS becomes higher than a second threshold value), the external control unit 501 may output a mode setting command C4 including a mode setting value LDC_Mode which equals 0.and the mode setting value LDC_Mode=0 may be used to request to set the LDC mode according to the predefined LDC setting data LDC_SET0. The control register 450 may store the mode setting value LDC_Mode=0.

At a period from time t8 to time t9, the protecting unit 460 may determine whether the mode setting value carried in the mode setting command C4 is reasonable according to the ambient light sensing signal AS or an image analysis result.

As shown in FIG. 5, the protecting unit 460 determines that the mode setting value (LDC_Mode=0) carried in the mode setting command C4 is reasonable so that at time t9, the protecting unit 460 changes the error indication EI to a logic low value corresponding to the determination result which presents that the mode setting value is reasonable. The error indication EI may be used to notify the front end that the abnormal situation has been resolved. At time t9, as shown in the timing diagram DS2, the microcontroller unit 410 reads the predefined LDC setting data LDC_SET0 from the storage unit 420 according to the mode setting value and writes the predefined LDC setting data LDC_SET0 to the local dimming control register 440 through the internal bus. Thus, at time t10, in a period next to the period during which the microcontroller unit 410 completes reading and writing the predefined LDC setting data LDC_SET0, LDC setting data of the display control circuit 400 may be updated to the predefined LDC setting data LDC_SET0.

Therefore, the display control circuit 400 may enable rapid switching of local dimming settings without producing unpredictable transient display results, and may promptly notify the abnormal condition to the front end system by using the error indication EI.

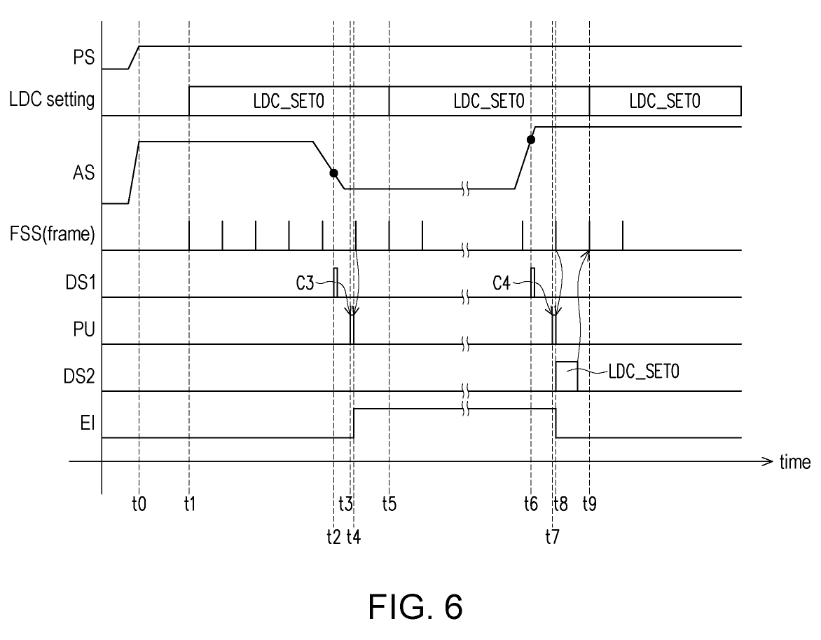

FIG. 6 is another schematic diagram of relevant signals according to the embodiment of FIG. 4 of the disclosure. Referring to FIG. 4 and FIG. 6, in another one embodiment of the disclosure, different from the embodiment of FIG. 5, after the protecting unit 460 generates the error indication EI corresponding to the determination result presenting that the mode setting value is unreasonable, the microcontroller unit 410 does not read the predefined LDC setting data LDC_SET3 from the storage unit 420 according to the mode setting value, and does not write the predefined LDC setting data LDC_SET3 corresponding to the mode setting value into the local dimming control register 440. Thus, at time t5, LDC setting data of the display control circuit 400 may be maintained, which is still the predefined LDC setting data LDC_SET0.

At time t6, when the brightness of ambient light is changed again (e.g., the voltage level of the ambient light sensing signal AS becomes higher than a second threshold value), the external control unit 501 may output the mode setting command C4 including a mode setting value LDC_Mode which equals 0. The control register 450 may store the mode setting value LDC_Mode=0.

At a period from time t7 to time t8, the protecting unit 460 may determine whether the mode setting value carried in the mode setting command C4 is reasonable according to the ambient light sensing signal AS or an image analysis result. As shown in FIG. 6, the protecting unit 460 determines that the mode setting value (LDC_Mode=0) carried in the mode setting command C4 is reasonable so that at time t8, the protecting unit 460 changes the error indication EI to a logic low value corresponding to the determination result presenting that the mode setting value is reasonable.

At time t8, as shown in the timing diagram DS2, the microcontroller unit 410 reads the predefined LDC setting data LDC_SET0 from the storage unit 420 according to the mode setting value (LDC_Mode=0) and writes the predefined LDC setting data LDC_SET0 to the local dimming control register 440. Thus, at time t9, which is in a period next to the period during which the microcontroller unit 410 completes reading and writing the predefined LDC setting data LDC_SET0, LDC setting data of the display control circuit 400 may be updated to the predefined LDC setting data LDC_SET0.

Therefore, the display control circuit 400 may enable maintain local dimming setting under scene changes without producing unpredictable transient display results, and may promptly notify the abnormal condition to the front end via the error indication EI.

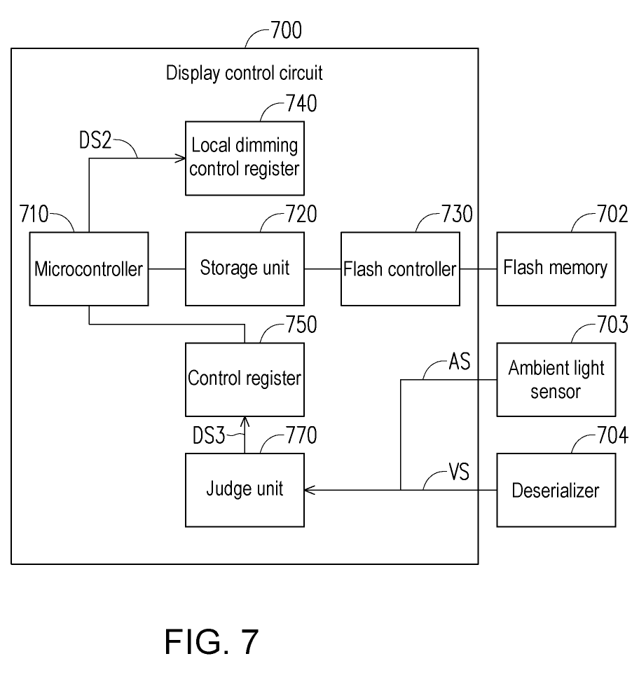

FIG. 7 is a circuit schematic diagram of a display control circuit according to an embodiment of the disclosure. Referring to FIG. 7, the display control circuit 700 includes a microcontroller unit 710, a storage unit 720, a flash controller 730, a local dimming control register 740, a control register 750, and a judge unit 770. The microcontroller unit 710 is coupled to the storage unit 720, the local dimming control register 740, and a control register 750. The storage unit 720 is further coupled to the flash controller 730. The control register 750 is further coupled to the judge unit 770. The flash controller 730 is coupled to a flash memory 702. The judge unit 770 is further coupled to an ambient light sensor 703 and a deserializer 704. In one embodiment of the disclosure, the judge unit 770 may be integrated into the microcontroller unit 710, or may be implemented as other circuits in the display control circuit 700.

In the embodiment of the disclosure, the ambient light sensor 703 is configured to sense the brightness of ambient light (e.g., the ambient light inside or outside the car) to output an ambient light sensing signal AS to the judge unit 770. The deserializer 704 is configured to provide a video signal VS for driving the display panel to display corresponding video image. The deserializer 704 outputs the video signal VS to the judge unit 770. In the embodiment of the disclosure, the judge unit 770 is configured to identify and switch the LDC mode according to at least one of the ambient light sensing signal AS and the video signal VS, and is configured to generate a mode setting value according to the identification result. That is, the display control circuit 700 is capable of generating the mode setting value on its own. In addition, the relevant circuit features and technical details of the display control circuit 700 can be found in the embodiments illustrated in FIG. 1 to FIG. 2. The display control circuit 700 may also execute the display control method of the embodiment of FIG. 2. Different from the display control circuit 100 in FIG. 1 and the display control circuit 400 in FIG. 4 which depend upon the external control unit transmitting information of which LDC mode is used, the display control circuit 700 determines the LDC mode without referring to the mode setting value transmitted from the external control unit.

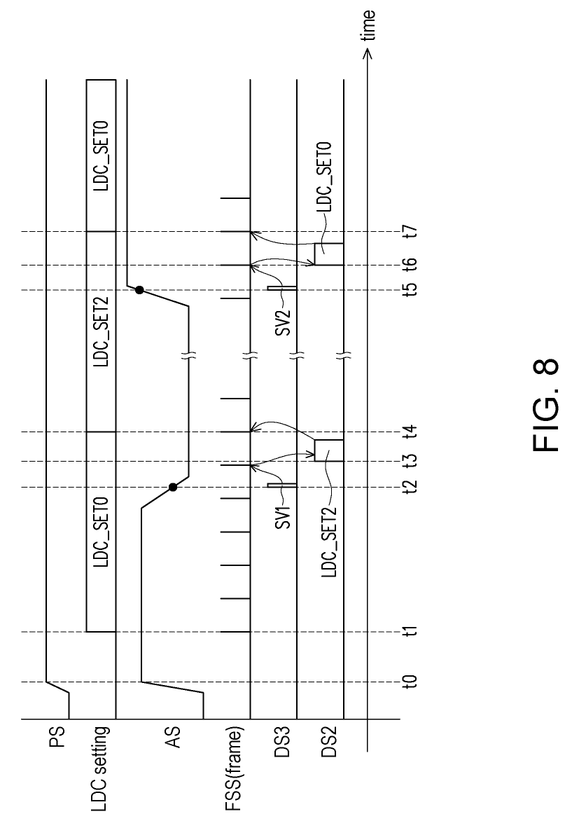

FIG. 8 is a schematic diagram of relevant signals according to the embodiment of FIG. 7 of the disclosure. Referring to FIG. 7 and FIG. 8, PS depicts a timing diagram of a power supplying state to the display control circuit 700; LDC setting depicts a timing diagram of LDC setting data stored in the local dimming control register 740; AS depicts a timing diagram of the ambient light sensing signal; FSS depicts a timing diagram of a frame synchronization signal; DS2 depicts a timing diagram of a transmission on the internal bus between the microcontroller unit 710 and the local dimming control register 740; and DS3 depicts a timing diagram of the operation of the judge unit 770. The display control circuit 700 may be powered on at time t0. During a period between time t0 to time t1, the flash controller 730 may read a plurality of predefined LDC setting data (e.g., LDC_SET0 to LDC_SET3) from the flash memory 702 in advance, and write the plurality of predefined LDC setting data into storage unit 720. Before receiving a mode setting command for local dimming control, the microcontroller unit 710 first sets an initial LDC mode. The way to set the initial LDC mode is similar to the abovementioned initial setting flow given in the descriptions of FIG. 3 and FIG. 5, and is omitted herein.

Refer to the timing diagram DS3, at time t2, when the brightness of ambient light is changed (e.g., the voltage level of the ambient light sensing signal AS becomes lower than a first threshold value), the judge unit 770 may determine a LDC mode according to the ambient light sensing signal AS or an image analyzing result (generated based on the video signal VS), and the judge unit 770 may output a corresponding mode setting value SV1 (e.g., for setting the LDC_Mode=2) to the control register 750.

For example, the judge unit 770 may determine the scene is a low-light environment (e.g., the vehicle traveling inside a tunnel) according to the ambient light sensing signal AS, so the judge unit 770 may output the mode setting value SV1 corresponding to the LDC mode 2 to the control register 750. Therefore, the microcontroller unit 710 may write the predefined LDC setting data LDC_SET2 into the local dimming control register 740, wherein the LDC mode configured by the mode setting value SV1 (corresponding to the LDC mode 2)can adjust the grayscale of warning icons in an input image frame displayed on the display panel to a high-brightness display effect.

At time t3, the microcontroller unit 710 may read the predefined LDC setting data LDC_SET2 from the storage unit 720 according to the mode setting value SV1 and write the predefined LDC setting data LDC_SET2 into the local dimming control register 740 through the internal bus. Thus, at time t4, LDC setting data of the display control circuit 700 may be updated to the predefined LDC setting data LDC_SET2.

At time t5, when the brightness of ambient light is changed again (e.g., the voltage level of the ambient light sensing signal AS becomes higher than a second threshold value), the judge unit 770 may determine the LDC mode according to the ambient light sensing signal AS or an image analysis result (generated based on the video signal VS,) and the judge unit 770 may output another mode setting value SV2 corresponding to another LDC mode 0 to the control register 750. The control register 750 may store the another mode setting value SV2.

At time t6, the microcontroller unit 710 may read the predefined LDC setting data LDC_SET0 from the storage unit 720 according to the mode setting value SV2 and write the predefined LDC setting data LDC_SET0 into the local dimming control register 740. Thus, at time t7, LDC setting data of the display control circuit 700 may be updated to the predefined LDC setting data LDC_SET0.

For example, the judge unit 770 may determine that the scene has returned to a normal brightness environment based on the ambient light sensing signal AS. Therefore, the judgment unit 770 may output the mode setting value SV2 to the control register 750. As a result, the microcontroller unit 710 may write the predefined LDC setting data LDC_SET2 into the local dimming control register 740, thereby restoring the original local dimming effect.

Therefore, the display control circuit 700 may enable rapid switching of local dimming settings without producing unpredictable transient display results.

The display control circuits 100, 400, and 700 may be implemented in an integrated circuit (IC) which perform local dimming control of backlight, such as a bridge IC, a timing controller (TCON) IC, or a timing controller embedded display driver IC (TED), and the display control circuit 100 may be configured to providing display data and control signals for driving the display panel and a backlight panel of an instrument cluster or a center information display (CID).

In summary, the display control circuit and the display control method of the disclosure may achieve rapid scene mode switching and may be combined with ambient light sensing or image sensing to achieve adaptive local dimming. The display control circuit and the display control method of the disclosure may also automatically determine whether the mode switching is reasonable and generate corresponding notifications to the front end.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display control circuit, comprising:
a storage unit, for storing a plurality of predefined local dimming control (LDC) setting data;
a control register, configured to store a first mode setting value;
a local dimming control register, configured to store a LDC setting data that is to be applied in synchronization with a frame synchronization signal; and
a microcontroller unit, coupled to the control register and the local dimming control register, and configured to read a first predefined LDC setting data of the plurality of predefined LDC setting data stored in the storage unit according to the first mode setting value and write the first predefined LDC setting data into the local dimming control register.

2. The display control circuit according to claim 1, wherein the first mode setting value is carried in a mode setting command transmitted from an external control unit.

3. The display control circuit according to claim 2, wherein the microcontroller unit finishes reading and writing the first predefined LDC setting data during one frame period next to a frame period during which the microcontroller unit receives the mode setting command.

4. The display control circuit according to claim 1, wherein the control register is further configured to store an input LDC setting data transmitted from an external control unit, and the microcontroller unit is further configured to read the input LDC setting data from the control register and write the input LDC setting data to the local dimming control register.

5. The display control circuit according to claim 4, wherein the microcontroller unit finishes reading and writing the input LDC setting data in one frame period next to a frame period during which the microcontroller unit completes receiving the input LDC setting data.

6. The display control circuit according to claim 2, further comprising:
a protecting unit, coupled to the control register, and configured to determine whether the first mode setting value carried in the mode setting command is reasonable and generate an error indication corresponding to a determination result which presents that the first mode setting value is reasonable or unreasonable.

7. The display control circuit according to claim 6, wherein the protecting unit determines whether the first mode setting value is reasonable according to an ambient light sensing signal.

8. The display control circuit according to claim 6, wherein the protecting unit determines whether the first mode setting value is reasonable according to an image analysis result.

9. The display control circuit according to claim 6, wherein after the protecting unit generates the error indication corresponding to the determination result presenting that the first mode setting value is unreasonable, the microcontroller unit reads the first predefined LDC setting data from the storage unit and writes the first predefined LDC setting data into the local dimming control register even though the determination result presents that the first mode setting value is unreasonable.

10. The display control circuit according to claim 6, wherein the microcontroller unit reads the first predefined LDC setting data from the storage unit and writes the first predefined LDC setting data into the local dimming control register only when the protecting unit generates the error indication corresponding to the determination result presenting that the first mode setting value is reasonable.

11. The display control circuit according to claim 6, wherein after the control register is overwritten with a second mode setting value carried in the mode setting command and the protecting unit generates another error indication corresponding to a determination result which presents that the second mode setting value is unreasonable, the microcontroller unit does not write a second predefined LDC setting data corresponding to the second mode setting value into the local dimming control register.

12. The display control circuit according to claim 1, wherein the first mode setting value is generated by the display control circuit.

13. The display control circuit according to claim 12, further comprising a judge unit, configured to determine a LDC mode according to an ambient light sensing signal or a video signal and output the first mode setting value corresponding to the LDC mode to the control register.

14. A display control method, comprising:
storing a first mode setting value by a control register;
reading a first predefined local dimming control (LDC) setting data of a plurality of predefined LDC setting data stored in a storage unit by a microcontroller unit according to the first mode setting value; and
writing the first predefined LDC setting data into a local dimming control register by the microcontroller unit,
wherein the local dimming control register is configured to store a predefined LDC setting data that is applied in synchronization with a frame synchronization signal.

15. The display control method according to claim 14, wherein the first mode setting value is carried in a mode setting command transmitted from an external control unit.

16. The display control method according to claim 15, wherein the microcontroller unit finishes reading and writing the first predefined LDC setting data during one frame period next to a frame period during which the microcontroller unit receives the mode setting command.

17. The display control method according to claim 14, further comprising:
storing an input LDC setting data transmitted from an external control unit by the control register; and
reading the input LDC setting data from the control register by the microcontroller unit, and writing the input LDC setting data to the local dimming control register by the microcontroller unit.

18. The display control method according to claim 17, wherein the microcontroller unit finishes reading and writing the input LDC setting data in one frame period next to a frame period during which the microcontroller unit completes receiving the input LDC setting data.

19. The display control method according to claim 15, further comprising:
determining whether the first mode setting value carried in the mode setting command is reasonable by a protecting unit; and
generating an error indication corresponding to a determination result which presents that the first mode setting value is reasonable or unreasonable by the protecting unit.

20. The display control method according to claim 19, further comprising:
determining whether the first mode setting value is reasonable by the protecting unit according to an ambient light sensing signal.

21. The display control method according to claim 19, further comprising:
determining whether the first mode setting value is reasonable by the protecting unit according to an image analysis result.

22. The display control method according to claim 19, further comprising:
after the protecting unit generates the error indication corresponding to the determination result presenting that the first mode setting value is unreasonable, reading the first predefined LDC setting data from the storage unit by the microcontroller unit, and writing the first predefined LDC setting data into the local dimming control register by the microcontroller unit even though the determination result presents that the first mode setting value is unreasonable.

23. The display control method according to claim 19, further comprising:
reading the first predefined LDC setting data from the storage unit by the microcontroller unit; and
writing the first predefined LDC setting data into the local dimming control register by the microcontroller unit only when the protecting unit generates the error indication corresponding to the determination result presenting that the first mode setting value is reasonable.

24. The display control method according to claim 19, further comprising:
after the control register is overwritten with a second mode setting value carried in the mode setting command and the protecting unit generates another error indication corresponding to a determination result which presents that the second mode setting value is unreasonable, not writing a second predefined LDC setting data corresponding to the second mode setting value into the local dimming control register by the microcontroller unit.

25. The display control method according to claim 14, further comprising:
generating the first mode setting value by the display control circuit.

26. The display driving method according to claim 25, further comprising:
determining a LDC mode by a judge unit according to an ambient light sensing signal or a video signal; and
outputting the first mode setting value corresponding to the LDC mode to the control register by the judge unit.
